(19) United States
(12) Patent Application Publication
(10) Pub. No.: US 2004/0009286 A1
(43) Pub. Date: Jan. 15, 2004

(54) Tapioca ball and process of preparing same

(75) Inventor: J. C. Tsou, Shanghai (CN)

Correspondence Address: Jay B. Johnson, Esq., Baker Botts L.L.P., 2100 Ross Avenue, Dallas, TX, 75201-2980, US

(73) Assignee: SHANGHAI ZHOUSHI FOODSTUFFS CO., LTD.

(21) Appl. No.: 10/284,533

(22) Filed: Oct. 30, 2002

(30) Foreign Application Priority Data
Jul. 10, 2002 (CN) 02112470.1

(51) Int. Cl. A23K 1/00

(52) U.S. Cl. 426/615

(57) ABSTRACT

A tapioca ball and a process for preparing the tapioca ball are provided. In one embodiment, the process includes mixing starch, sugar, and sodium hydroxymethyl cellulose. Water is added to the mixture. The mixture is rolled in a rolling cylinder to bond the ingredients and to form spherical tapioca balls. The tapioca balls are quickly boiled for two to fifteen minutes. After drip-drying, the tapioca balls are vibrated on a first oscillating screen, while being sprayed uniformly with a drying powder. Then, the tapioca balls are shaken on a second oscillating screen to shake excess drying powder off the tapioca balls. The tapioca balls are then polished in a polishing cylinder and packaged. The tapioca balls may comprise, by weight, 60% to 80% tapioca powder, 5% to 35% starch, 1% to 10% sugar, 1% to 10% hydroxymethyl cellulose, and 10% to 45% water.

### TECHNICAL FIELD OF THE INVENTION

The invention relates to food and food processing, and in particular, to tapioca balls and a process for preparing tapioca balls.

### BACKGROUND OF THE INVENTION

Known pastries include those made from sago, shelled rice, glutinous rice dumplings, and tapioca balls. Dumplings have many kinds of stuffing, but the surface layers are typically glutinous rice. Glutinous rice is uneasy to digest and, thus, does not meet modern dietary requirements. Chinese Patent 95113374.8, entitled “The Process for Preparing Tapioca Ball,” discusses a tapioca ball made from sweet potato powder, but both its packaging and transportation are inconvenient, because the resulting tapioca balls are easy to crack. The waste of materials causes great losses in revenue. Also, this type of tapioca ball takes approximately thirty minutes to cook, and another thirty minutes to braise, which results in an undesirably long preparation time.

### SUMMARY OF THE INVENTION

An object of the present invention is to provide a tapioca ball, which can be cooked easily and is uneasy to crack, and a process for preparing such a tapioca ball.

According to an embodiment of the present invention, a process for preparing the tapioca ball is provided. A base of tapioca powder is provided as a main raw ingredient. A small amount of starch and a trace of sugar and sodium hydroxymethyl cellulose are added. The resulting mixture is placed into a rolling cylinder after stirring water into the mixture. The cylinder is rolled causing the ingredients of the mixture to bond to each other and form spherical tapioca balls. These tapioca balls are boiled quickly for two to fifteen minutes. The balls are drip-dried. Then the balls are placed onto a first oscillating screen. The balls are vibrated while being sprayed uniformly with a drying powder. Then, the balls are placed onto a second oscillating screen to shake the excess drying powder off the tapioca balls. The balls are then placed into a polishing cylinder to polish them. Then the balls are packed.

According to another embodiment, a process for preparing tapioca balls is provided. A mixture is provided comprising, by weight, 60% to 80%, tapioca powder, 5% to 35% starch, 1% to 10% sugar, and 1% to 10% sodium hydroxymethyl cellulose, and 10% to 45% water. This mixture is placed into a rolling cylinder and the cylinder is rolled to cause the ingredients to bond and form spherical tapioca balls. Then, these tapioca balls are boiled quickly for two to fifteen minutes. Then, the balls are drip-dried. Then, the balls are placed onto a first oscillating screen. The balls are vibrated while being sprayed uniformly with a drying powder. Then, the balls are placed onto a second oscillating screen to shake excess drying powder off the tapioca balls. The balls are placed into a polishing cylinder to polish them. Then, the balls are packaged.

According to another embodiment, the tapioca balls comprise, by weight, 60% to 80% tapioca powder, 5% to 35% starch, 1% to 10% sugar, 1% to 10% sodium hydroxymethyl cellulose, 10% to 45% water, and 1% to 8% drying powder.

According to another embodiment, the tapioca balls comprise, by weight, 60% to 75% tapioca powder, 5% to 15% starch, 1% to 5% sugar, 1% to 3% hydroxymethyl cellulose, and 15% to 20% water.

Certain advantages are discussed below. Some of the embodiments may provide some, none, or all of these advantages. The process provided by certain embodiments results in tapioca balls having partially-cooked interiors and exteriors which are coated with drying powder. The tapioca balls are thereby uneasy to crack and can be transported conveniently. Another advantage is a shorter cooking time as compared with known processes. The result of certain embodiments is a glutinous, sweet, delicious and nourishing dessert, which is easy to digest.

### BRIEF DESCRIPTION OF THE DRAWINGS

For a more complete understanding of the present invention and its advantages, reference is now made to the following description, taken in conjunction with the accompanying drawing, in which:

FIG. 1 is a flowchart depicting an example process according to an embodiment of the present invention.

### DETAILED DESCRIPTION OF EXAMPLE EMBODIMENTS

Among other things, the present invention provides a process for preparing tapioca balls. One difference from the existing technology, for certain embodiments, is to incorporate tapioca powder as the main raw material ingredient, and add a small amount of starch, and a trace of sugar and sodium hydroxymethyl cellulose.

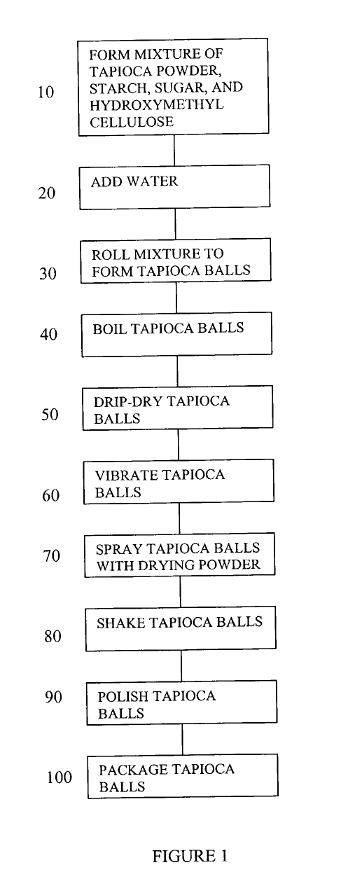

According to an embodiment of the present invention, a process for making tapioca balls is provided. According to the process, as shown in FIG. 1, in a first step 10, a mixture of tapioca powder, starch, sugar and hydroxymethyl cellulose is provided. Preferably, the tapioca powder is the main ingredient of this mixture. Preferably, the amount of starch is small relative to the amount of tapioca powder, and the amount of sugar and the amount of hydroxymethyl cellulose can be characterized as a trace amount. Preferably, the amount of sugar and the amount of hydroxymethyl cellulose are each small compared to the amount of starch. In a next step 20, water is added to the mixture, preferably by stirring. In a next step 30, the mixture is rolled in a rolling cylinder to cause the ingredients of the mixture to bond to each other. In a next step 40, the tapioca balls are quickly boiled, preferably for two to fifteen minutes. Under certain circumstances, three to five minutes is a more preferable boiling time. In a next step 50, the tapioca balls are dried, preferably by drip-drying. In a next step 60, the tapioca balls are vibrated on a first oscillating screen. In a next step 70, the tapioca balls are sprayed with a drying powder. Preferably, the tapioca balls are substantially uniformly sprayed. The spraying step 70 and vibrating step 60 can occur at the same time. The spraying step reduces cracking of the tapioca balls and causes the balls not to bond to each other into lumps. In a next step 80, the tapioca balls are shaken on a second oscillating screen to shake the excess drying powder off the tapioca balls. The first and second oscillating screens may be the same screen. In a next step 90, the tapioca balls are polished in a polishing cylinder. In a next step 100, the tapioca balls are packaged.

According to another embodiment, a tapioca ball is provided, which comprises tapioca powder, starch, sugar, sodium hydroxymethyl cellulose, drying powder and water. These ingredients may be present according to weight percentages of 60% to 80% tapioca powder, 5% to 35% starch, 1% to 10% sugar, 1% to 10% sodium hydroxymethyl cellulose, 10% to 45% water and 1% to 8% drying powder. More preferably, the amount of drying powder is, by weight, from 2% to 4%. In the following examples, the starch used is acetylated starch. The sugar used may be sucrose, refined sugar or caramel. The drying powder is composed of tapioca powder, konjoc powder and guar gum, preferably in weight percentage amounts of 80% to 98% tapioca powder, 1% to 15% konjoc powder, and 1% to 15% guar gum. The specific types of ingredients used are examples only, and other types may be substituted.

The tapioca balls of the present invention are uneasy to crack and, therefore, result in a low loss rate during transportation. Also, the tapioca balls have a shorter cooking time, which saves time.

Several examples of preparation processes, according to various embodiments of the present invention, will now be discussed. In the following examples, the percentages during the preparation process refer to weight percentages.

### EXAMPLE 1

Mix 60% high quality tapioca powder, 15% potato starch, 1% sugar, 2% sodium hydroxymethyl cellulose, and 18% water. Roll this mixture in a rolling cylinder to cause the ingredients to bond to each other to form spherical tapioca balls. Boil these tapioca balls quickly for approximately three minutes. After drip-drying the tapioca balls, vibrate the tapioca balls on a first oscillating screen while uniformly spraying the tapioca balls with a drying powder. Shake the tapioca balls on a second oscillating screen to shake the excess drying powder off the tapioca balls. Polish the tapioca balls in a polishing cylinder and then package them. The weight percentage of drying powder is 98% tapioca powder, 1% konjoc powder and 1% guar gum.

### EXAMPLE 2

Mix 65% high quality tapioca powder, 8% starch, 2% caramel, 2% sodium hydroxymethyl cellulose, and 20% water. Roll this mixture in a rolling cylinder to cause the ingredients to bond to each other to form spherical tapioca balls. Boil these tapioca balls quickly for approximately five minutes. After drip-drying the tapioca balls, vibrate them on a first oscillating screen while spraying them uniformly with 4% drying powder. Shake the tapioca balls in a second oscillating screen to shake the drying powder off the tapioca balls. Polish the tapioca balls in a polishing cylinder and then package them. The weight percentage of drying powder is 97% tapioca powder, 2% konjoc powder, and 1% guar gum.

### EXAMPLE 3

Mix 70% tapioca powder, 5% starch, 3% caramel, 1% sodium hydroxymethyl cellulose, and 20% water. Roll this mixture in a rolling cylinder to cause the ingredients to bond to each other to form spherical tapioca balls. Boil these tapioca balls quickly for approximately five minutes. After drip-drying the tapioca balls, vibrate them on a first oscillating screen while spraying them uniformly with 3% drying powder. Shake the tapioca balls in a second oscillating screen to shake the excess drying powder off the tapioca balls. Polish the tapioca balls in a polishing cylinder and then package them. The weight percentage of drying powder is 96% tapioca powder, 2% konjoc powder, and 2% guar gum.

### EXAMPLE 4

Mix 65% tapioca powder, 10% starch, 5% caramel, 2% sodium hydroxymethyl cellulose and 15% water, roll this mixture in a rolling cylinder to cause the ingredients to bond to each other to form spherical tapioca balls. Boil these tapioca balls quickly for approximately five minutes. After drip-drying the tapioca balls, vibrate them on a first oscillating screen while spraying them uniformly with 3% drying powder. Shake the tapioca balls on a second oscillating screen to shake the excess drying powder off the tapioca balls. Polish the tapioca balls in a polishing cylinder and then package them. The weight percentage of drying powder is 95% tapioca powder, 2% konjoc powder, and 3% guar gum.

### EXAMPLE 5

Mix 75% tapioca powder, 12% starch, 4% caramel, 3% sodium hydroxymethyl cellulose, and 20% water. Roll this mixture in a rolling cylinder to cause the ingredients to bond to each other to form spherical tapioca balls. Boil these tapioca balls quickly for approximately five minutes. After drip-drying the tapioca balls, vibrate them on a first oscillating screen while spraying them uniformly with 2% drying powder. Shake the tapioca balls on a second oscillating screen to shake the excess drying powder off the tapioca balls. Polish the tapioca balls in a polishing cylinder and then package them. The weight percentage of drying powder is 94% tapioca powder, 3% konjoc powder, and 3% guar gum.

Although the present invention has been described in several embodiments, myriad changes and modifications are suggested to and may be made by one skilled in the art, and it is intended that the present invention encompass such changes and modifications as fall within the scope of the appended claims.

What is claimed is:

1. A process for preparing a tapioca ball, comprising:
forming a mixture of tapioca powder, starch, sugar and sodium hydroxymethyl cellulose; and
forming tapioca balls from the mixture.

2. The process of claim 1, further comprising:
boiling the tapioca balls; and
spraying the tapioca balls with a drying powder.

3. The process of claim 1, further comprising adding water into the mixture before forming the tapioca balls.

4. The process of claim 2, further comprising drip-drying the tapioca balls after boiling the tapioca balls.

5. The process of claim 2, further comprising vibrating the tapioca balls after boiling the tapioca balls.

6. The process of claim 5, where the vibrating step is accomplished by vibrating the tapioca balls on a first oscillating screen.

7. The process of claim 5, wherein the vibrating step and the spraying step are at least partially accomplished at the same time.

8. The process of claim 5, further comprising shaking the tapioca balls after the spraying step to shake off the excess drying powder.

9. The process of claim 2, further comprising shaking the tapioca balls after the spraying step to shake off excess drying powder.

10. The process of claim 2, further comprising polishing the tapioca balls after the spraying step.

11. The process of claim 2, wherein the boiling step comprises boiling the tapioca balls for two to fifteen minutes.

12. The process of claim 2, wherein the boiling step comprises boiling the tapioca balls for three to five minutes.

13. The process of claim 1, wherein the mixture comprises, by weight, 60% to 80% tapioca powder, 5% to 35% starch, 1% to 10% sugar, and 1% to 10% hydroxymethyl cellulose.

14. The process of claim 1, wherein the mixture comprises, by weight, 60% to 75% tapioca powder, 5% to 15% starch, 1% to 5% sugar, and 1% to 3% hydroxymethyl cellulose.

15. The process of claim 14, wherein the mixture further comprises, by weight, 10% to 45% water.

16. The process of claim 14, wherein the amount of water is 19% to 20%.

17. The process of claim 2, wherein the drying powder comprises, by weight, 80% to 98% tapioca powder, 1% to 19% konjoc powder, and 1% to 15% guar gum.

18. The process of claim 2, wherein the drying powder comprises, by weight, 94% to 98% tapioca powder, 1% to 35 konjoc powder, and 1% to 3% guar gum.

19. A process for preparing a tapioca ball, comprising:
mixing, by weight, 60% to 80% tapioca powder, 5% to 35% starch, 1% to 10% sugar, 1% to 10% sodium hydroxymethyl cellulose, and 10% to 45% water; and
forming tapioca balls from the mixture.

20. The process of claim 19, further comprising:
boiling the tapioca balls; and
spraying the tapioca balls with a drying powder.

21. The process of claim 20, further comprising drip-drying the tapioca balls after the boiling step.

22. The process of claim 20, further comprising vibrating the tapioca balls after the boiling step.

23. The process of claim 20, further comprising shaking the tapioca balls after the spraying step.

24. The process of claim 19, further comprising polishing the tapioca balls.

25. The process of claim 20, wherein the drying powder comprises, by weight, 80% to 98% tapioca powder, 1% to 19% konjoc powder, and 1 % to 15% guar gum.

26. A tapioca ball, by weight, comprising:
60% to 80%, by weight, tapioca powder;
5% to 35%, by weight, starch;
1% to 10%, by weight, sugar; and
1% to 10%, by weight, sodium hydroxymethyl cellulose.

27. The tapioca ball of claim 26, further comprising 10% to 45%, by weight, water.

28. The tapioca ball of claim 26, further comprising 1% to 8%, by weight, drying powder.

29. The tapioca ball of claim 28, wherein the drying powder comprises, by weight, 80% to 98% tapioca powder, 1% to 19% konjoc powder, and 1% to 15% guar gum.

30. A tapioca ball, comprising:
60% to 75%, by weight, tapioca powder;
5% to 15%, by weight, starch;
1% to 5%, by weight, sugar; and
1% to 3%, by weight, hydroxymethyl cellulose.

31. The tapioca ball of claim 30, further comprising 15% to 20%, by weight, water.

32. The tapioca ball of claim 30, further comprising 2% to 4%, by weight, drying powder.

33. The tapioca ball of claim 32, wherein the drying powder comprises, by weight, 80% to 98% tapioca powder, 1% to 19% konjoc powder, and 1% to 15% guar gum.
